(19) United States
(12) Patent Application Publication
(10) Pub. No.: US 2026/0076368 A1
(43) Pub. Date: Mar. 19, 2026

(54) HERBICIDAL COMPOSITION COMPRISING BIFENOX AND VLCFA INHIBITOR

(71) Applicant: ADAMA AGAN LTD., Ashdod (IL)

(72) Inventors: Andrew HORSFIELD, Bracken Ridge (AU); Balázs VARGA, Gyomro (HU)

(73) Assignee: ADAMA AGAN LTD., Ashdod (IL)

(21) Appl. No.: 19/102,699

(22) PCT Filed: Aug. 10, 2023
(86) PCT No.: PCT/IL2023/050834

§ 371 Date: Feb. 10, 2025

Related U.S. Application Data
(60) Provisional application No. 63/396,638, filed on Aug. 10, 2022.

(51) Int. Cl. A01N 37/48; A01N 37/22; A01N 37/26; A01N 43/10; A01N 43/12; A01N 43/80; A01N 43/82; A01N 47/12; A01P 13/02

(52) U.S. Cl. CPC A01N 37/48; A01N 37/22; A01N 37/26; A01N 43/10; A01N 43/12; A01N 43/80; A01N 43/82; A01N 47/12; A01P 13/02

(57) ABSTRACT

The present invention provides an herbicidal mixture or its composition thereof comprises an herbicide A which is bifenox and an herbicide B which is selected from very long chain fatty acid (VLCFA) inhibitor or salt thereof for the control of weeds and grasses in crops of the cultivated plants.

### FIELD OF THE INVENTION

The present invention relates to an herbicidal mixture or composition. More particularly, the present invention relates to an herbicidal mixture or its composition thereof comprising of an herbicide A which is bifenox and an herbicide B which is selected from very long chain fatty acid (VLCFA) inhibitor or salt thereof for the control of weeds and grasses in crops of the cultivated plants.

### BACKGROUND OF THE INVENTION

The control of undesired vegetation is extremely important in order to achieve high crop efficiency. Weeds cause damage to agricultural crops and adversely affect crop productivity by competing with the crop for mineral nutrients, nitrogen, water and sunlight.

Herbicides have a phytotoxic effect on unwanted plants and so they are used in plant protection for controlling weeds or totally inhibiting their growth. Herbicides can be non-selective, which means that they can destroy all growth. Other types of herbicides are selective herbicides which kill specific target plants while leaving the desired/economically important plants relatively unharmed, some of these acts by interfering with the growth of the weed and are often synthetic mimics of natural plant hormones. However, these herbicides may not be effective against certain type of other weeds which may also be present in the crop to be protected.

Therefore, there is a strong need for mixing two or more herbicides. Unfortunately, most of such herbicides exhibit phytotoxicity to the economically important plants as well as to the target plants called weeds which are sought to be controlled.

Mixtures of selected herbicides have several advantages over the use of a single herbicide including (a) an increase in the spectrum of weeds controlled or an extension of weed control over a longer period of time; (b) an improvement in crop safety by using minimum doses of selected herbicides applied in combination rather than a single high dose of one herbicide; and (c) a delay in the appearance of resistant weed species to selected herbicides.

WO2000027203A1 patent application discloses an herbicidal composition for the selective control of broad-leaved weeds and grasses in crops resistant to protoporphyrinogen oxidase inhibitors comprising an herbicide which inhibits the action of protoporphyrinogen oxidases (for example, bifenox); and at least one further pesticide selected from the group consisting of co-herbicides, fungicides and insecticides/parasites. It does not disclose any working example on the combination of bifenox and with other herbicidal compounds.

Therefore, there exists a need in the art to develop an herbicidal mixture or its composition, which is stable, synergistic in nature, broad spectrum, and environmentally safe in control of weeds and grasses in crops of the cultivated plants. The herbicidal mixture or its composition must show a broader scope of activity to avoid or to prevent the development of resistant varieties of weeds to the active ingredients used by farmer while minimising the doses of chemicals sprayed in the agriculture fields.

As a solution to the above-mentioned problems, the inventors of the present invention surprisingly found that an effective amount of the herbicidal mixture or its composition thereof comprises an herbicide A which is bifenox and an herbicide B which is selected from very long chain fatty acid inhibitor for controlling the weeds and grasses in crops of the cultivated plants.

### SUMMARY OF THE INVENTION

An herbicidal mixture comprising an herbicide A which is bifenox and an herbicide B which is selected from very long chain fatty acid (VLCFA) inhibitor or salt thereof.

An herbicidal composition comprising an herbicide A which is bifenox and an herbicide B which is selected from very long chain fatty acid (VLCFA) inhibitor or salt thereof and at least one agriculturally acceptable carrier.

In another aspect, the present invention provides a method of controlling of weeds and grasses in crops of the cultivated plants comprising an herbicidal effective amount of an herbicide A which is bifenox, an herbicide B which is selected from very long chain fatty acid (VLCFA) inhibitor or salt thereof.

In an aspect, the present invention provides the very long chain fatty acid (VLCFA) inhibitor is selected from the group comprising dimethenamid, (S)-dimethenamid, pyroxasulfone, prosulfocarb, flufenacet, alachlor, acetochlor, metolachlor, (S)-metolachlor, tri-allate, fenoxasulfone, ethofumesate, dimethachlor or thiobencarb.

In a preferred aspect, the present invention provides an herbicidal composition is one of.
a) bifenox, dimethenamid and at least one agriculturally acceptable carrier;
b) bifenox, (S)-dimethenamid and at least one agriculturally acceptable carrier;
c) bifenox, pyroxasulfone and at least one agriculturally acceptable carrier;
d) bifenox, prosulfocarb and at least one agriculturally acceptable carrier;
e) bifenox, flufenacet and at least one agriculturally acceptable carrier;
f) bifenox, alachlor and at least one agriculturally acceptable carrier;
g) bifenox, acetochlor and at least one agriculturally acceptable carrier;
h) bifenox, metolachlor and at least one agriculturally acceptable carrier;
i) bifenox, (S)-metolachlor and at least one agriculturally acceptable carrier;
j) bifenox, tri-allate and at least one agriculturally acceptable carrier;
k) bifenox, fenoxasulfone and at least one agriculturally acceptable carrier;
l) bifenox, ethofumesate and at least one agriculturally acceptable carrier;
m) bifenox, dimethachlor and at least one agriculturally acceptable carrier;
n) bifenox, thiobencarb and at least one agriculturally acceptable carrier.

In another aspect, the present invention provides an herbicidal mixture or its composition thereof comprising herbicide A which is bifenox present in an amount of 5 to 80% w/w and the herbicide B which is selected from very long chain fatty acid inhibitor is present in an amount of 5 to 80% w/w.

In a preferred aspect, the present invention provides the herbicidal composition is one of:
a) bifenox is present in an amount of 5 to 80% w/w, dimethenamid is present in an amount of 5 to 80% w/w and at least one agriculturally acceptable carrier;
b) bifenox is present in an amount of 5 to 80% w/w, (S)-dimethenamid is present in an amount of 5 to 80% w/w and at least one agriculturally acceptable carrier;
c) bifenox is present in an amount of 20 to 60% w/w, pyroxasulfone is present in an amount of 10 to 40% w/w and at least one agriculturally acceptable carrier;
d) bifenox is present in an amount of 5 to 25% w/w, prosulfocarb is present in an amount of 50 to 80% w/w and at least one agriculturally acceptable carrier;
e) bifenox is present in an amount of 5 to 80% w/w, flufenacet is present in an amount of 5 to 80% w/w and at least one agriculturally acceptable carrier;
f) bifenox is present in an amount of 5 to 80% w/w, alachlor is present in an amount of 5 to 80% w/w and at least one agriculturally acceptable carrier;
g) bifenox is present in an amount of 5 to 80% w/w, acetochlor is present in an amount of 5 to 80% w/w and at least one agriculturally acceptable carrier;
h) bifenox is present in an amount of 5 to 50% w/w, metolachlor is present in an amount of 50 to 80% w/w and at least one agriculturally acceptable carrier;
i) bifenox is present in an amount of 5 to 50% w/w, (S)-metolachlor is present in an amount of 50 to 80% w/w and at least one agriculturally acceptable carrier;
j) bifenox is present in an amount of 5 to 50% w/w, tri-allate is present in an amount of 50 to 80% w/w and at least one agriculturally acceptable carrier;
k) bifenox is present in an amount of 25 to 60% w/w, fenoxasulfone is present in an amount of 30 to 65% w/w and at least one agriculturally acceptable carrier;
l) bifenox is present in an amount of 5 to 80% w/w, ethofumesate is present in an amount of 5 to 80% w/w and at least one agriculturally acceptable carrier;
m) bifenox is present in an amount of 5 to 80% w/w, dimethachlor is present in an amount of 5 to 80% w/w and at least one agriculturally acceptable carrier;
n) bifenox is present in an amount of 5 to 80% w/w, thiobencarb is present in an amount of 5 to 80% w/w and at least one agriculturally acceptable carrier.

In a further aspect, the present invention provides the relative amount of herbicide A to herbicide B is from 1:100 to 100:1 and preferably from 1:10 to 10:1.

In another aspect, the herbicidal composition of the present invention is formulated as Capsule suspension (CS), Dispersible concentrate (DC), Dustable powder (DP), Powder for dry seed treatment (DS), Emulsifiable concentrate (EC), Emulsifiable granule (EG), Emulsion water-in-oil (EO), Emulsifiable powder (EP), Emulsion for seed treatment (ES), Emulsion oil-in-water (EW), Flowable concentrate for seed treatment (FS), Granules (GR), Micro-emulsion (ME), Oil-dispersion (OD), Oil miscible flowable concentrate (OF), Oil miscible liquid (OL), Oil dispersible powder (OP), Suspension concentrate (SC), Suspension concentrate for direct application (SD), Suspo-emulsion (SE), Water soluble granule (SG), Soluble concentrate (SL), Spreading oil (SO), Water soluble powder (SP), Water soluble tablet (ST), Ultra-low volume (ULV) suspension, Tablet (TB), Ultra-low volume (ULV) liquid, Water dispersible granules (WG/WDG), Wettable powder (WP), Dry flowable (DF), Water dispersible powder for slurry seed treatment (WS), Water dispersible tablet (WT), a mixed formulation of CS and SC (ZC) or A mixed formulation of CS and SE (ZE), a mixed formulation of CS and EW (ZW). In a preferred embodiment, the composition is formulated as WG, SC, OD or EC.

In an aspect, the agriculturally acceptable carrier for the preparation of WG composition is selected from the group comprising surfactant, binder, antifoaming and filler.

In another aspect, the agriculturally acceptable carrier for the preparation of OD composition is selected from the group comprising solvent, surfactant, thickener, pH modifier, and antifoaming agent.

In a further aspect, the agriculturally acceptable carrier for the preparation of SC and EC composition is selected from the group comprising solvent, surfactant, anti-freezing agent, antifoaming, biocide, thickener, or pH modifier.

In an aspect, the solvent is selected from the group comprising water, aromatic hydrocarbon, alcohol, ethylene glycol, polypropylene glycol, dipropropylene glycol, N,N-dimethylformamide, dimethylsulfoxide, N-alkylpyrrolidone, oil, fatty acid ester, methylated or ethylated seed oil, ketone or a combination thereof and present in an amount of 5 to 80% w/w.

In another aspect, the surfactant is selected from the group comprising anionic, non-ionic, amphoteric, polymeric surfactant or a combination thereof and present in an amount of 0.01 to 20% w/w.

In a further aspect, the anti-freezing agent is selected from the group comprising glycerine, propylene glycol, diethylene glycol, monoethylene glycol or a combination thereof, and present in an amount of 1 to 6% w/w.

In an aspect, the present invention provides the antifoaming agent is selected from the group comprising silicone emulsion, dimethyl polysiloxane emulsion, polysiloxane emulsion and present in an amount of 0.01 to 0.50% w/w.

In yet another aspect, the biocide is selected from the group comprising 20% aqueous dipropylene glycol solution of 1,2-benzisothiazolin-3-one, formaldehyde, isothiazolinone or a combination thereof and present in an amount of 0.01 to 0.50% w/w.

In a further aspect, the pH modifier is selected from the group comprising sodium or potassium carbonate, sodium or potassium hydrogen carbonate, sodium or potassium dihydrogenphosphate, disodium or dipotassium hydrogenphosphate, citric acid, malic acid, triethanolamine, fatty acids such as lauric acid and oleic acid, fatty amines or a combination thereof and present in an amount of 0.01 to 2.00% w/w.

In an aspect, the filler is selected from the group comprising china clay, bentonite, precipitated silica, fused silica, fumed silica, lactose monohydrate or a combination thereof and present in an amount of 20 to 80% w/w.

In another aspect, the binder is selected from the group comprising starch, methylcellulose, carboxymethyl cellulose, polyvinylpyrrolidone, starch, polyethylene glycol or a combination thereof and present in an amount of 0.50 to 2% w/w.

In a further aspect, the herbicidal mixture or composition of the present invention further comprises a safener, wherein the safener is selected from the group comprising benoxacor, cloquintocet, cyometrinil, cyprosulfamide, dichlormid, dicyclonon, dietholate, fenchlorazole, fenclorim, flurazole, fluxofenim, furilazole, isoxadifen, jiecaowan, jiecaoxi, metcamifen, mefenpyr, mephenate, naphthalic anhydride, R-29148, AD-67, MG-191, oxabetrinil or esters thereof.

In an aspect, the present invention provides a method for controlling of weeds and grasses in crops of the cultivated plants, wherein an effective amount of an herbicidal mixture or its composition thereof comprising an herbicide A which is bifenox and an herbicide B which is selected from very long chain fatty acid inhibitor is applied to the crops of cultivated plants or their habitat.

In a further aspect, the herbicidal composition of the present invention is applied on the crops of cultivated plants are maize, sugar beet, fodder beet, soya beans, canola, oilseed rape, cotton, sunflower, cereals, sorghum, rice, forestry, turfgrass, sugar cane and non-crop areas at application rates which correspond to a total amount of active compound of from 100 to 5000 g per hectare or the composition at application rates from 0.1 to 10 liter/ha.

The above aspects and other objectives will become more apparent in view of the description given below.

### DETAILED DESCRIPTION OF THE INVENTION

In describing the embodiments of the invention, specific terminology is resorted for the sake of clarity. However, it is not intended that the invention be limited to the specific terms so selected, and it is to be understood that each specific term includes all technical equivalents that operate in a similar manner to accomplish a similar purpose.

It will be understood that the terminology used herein is for the purpose of describing embodiments only and is not intended to be limiting. As used in this specification, the singular forms “a”, “an” and “the” include plural referents unless the context clearly dictates otherwise. Thus, for example, the reference to “a surfactant” includes one or more of such surfactants.

Unless defined otherwise, all technical and scientific terms used herein have the same meaning as commonly understood by one ordinarily skilled in the art to which the invention pertains. Although other methods and materials similar, or equivalent, to those described herein can be used in the practice of the present invention, the preferred materials and methods are described herein.

As used herein, terms “comprises”, “comprising”, “includes”, “including”, or any other variation thereof, are intended to cover a non-exclusive inclusion, subject to any limitation explicitly indicated. For example, a composition or a method that comprises a list of elements is not necessarily limited to only those elements but may include other elements not expressly listed or inherent to such composition or method.

Throughout the application, descriptions of various embodiments use the term “comprising”; however, it will be understood by one of skill in the art, that in some specific instances, an embodiment can alternatively be described using the language “consisting essentially of” or “consisting of.”

As used herein, the term “composition” or “formulation” can be used interchangeably, unless stated otherwise, is meant to encompass, and are not limited to, composition or formulation containing the combination of bifenox and an herbicide which inhibits the action of very long chain fatty acid (VLCFA), or salt thereof.

As used herein, the term “effective amount” refers to an amount of the compound that, when ingested, contacted with or sensed, is sufficient to achieve a good level of control.

As used herein, the term “agriculturally acceptable carrier” refers to substances which are commonly used as to provide stability or to increase the activity profile of the composition or formulation with or without having agrochemical activity or direct effect on the undesired weeds.

As used herein, the term “surfactant” refers to a compound that, when dissolved in a liquid, reduces the surface tension of the liquid, which reduces the interfacial tension between two liquids, or which reduces surface tension between a liquid and a solid.

As used herein, the term “anti-freezing” refers to the agent used to prevent the aqueous composition from freezing.

As used herein, the term “anti-foaming” can be used interchangeably with “defoamer”. It is generally added to the composition to prevent the formation of foam.

As used herein, the term “biocide” refers to the agent used for the preservation against spoilage from bacteria, yeasts and fungi.

As used herein, the term “thickener” refers to a polymeric material, which at a low concentration increases the viscosity of an aqueous solution and helps to stabilize the composition.

As used herein, the term, % w/w refers to % of the weight of the respective component with respect to the total weight of the composition.

As used herein, the term “bifenox” encompasses bifenox or its agrochemically acceptable salt, derivative or any other modified form of bifenox.

As used herein, the term “very long chain fatty acid (VLCFA) inhibitor” encompasses the compound that inhibit the very long chain fatty acid synthesis. They specifically inhibits many elongation steps catalyzed by VLCFA elongases.

As used herein, the term “dimethenamid” encompasses dimethenamid or its agrochemically acceptable salt, derivative such as (S)-dimethenamid or any other modified form of dimethenamid.

As used herein, the term “pyroxasulfone” encompasses pyroxasulfone or its agrochemically acceptable salt, derivative or any other modified form of pyroxasulfone.

As used herein, the term “prosulfocarb” encompasses prosulfocarb or its agrochemically acceptable salt, derivative or any other modified form of prosulfocarb.

As used herein, the term “flufenacet” encompasses flufenacet or its agrochemically acceptable salt, derivative or any other modified form of flufenacet.

As used herein, the term “alachlor” encompasses alachlor or its agrochemically acceptable salt, derivative or any other modified form of alachlor.

As used herein, the term “acetochlor” encompasses acetochlor or its agrochemically acceptable salt, derivative or any other modified form of acetochlor.

As used herein, the term “metolachlor” encompasses metolachlor or its agrochemically acceptable salt, derivative such as (S)-metolachlor or any other modified form of metolachlor.

As used herein, the term “tri-allate” encompasses tri-allate or its agrochemically acceptable salt, derivative or any other modified form of tri-allate.

As used herein, the term “fenoxasulfone” encompasses fenoxasulfone or its agrochemically acceptable salt, derivative or any other modified form of fenoxasulfone.

As used herein, the term “ethofumesate” encompasses ethofumesate or its agrochemically acceptable salt, derivative or any other modified form of ethofumesate.

As used herein, the term “dimethachlor” encompasses dimethachlor or its agrochemically acceptable salt, derivative or any other modified form of dimethachlor.

As used herein, the term “thiobencarb” encompasses thiobencarb or its agrochemically acceptable salt, derivative or any other modified form of thiobencarb.

As used herein, the term “herbicide” or “herbicidal” refers to an active ingredient that kills, controls or otherwise adversely modifies the growth of plants. Herbicidally effective or vegetation controlling amount is an amount of one or more active ingredient which causes an adversely modifying effect and includes deviations from natural development, killing, regulation, desiccation, retardation and the like.

As used herein, the term “synergistic” refers to an interaction of two or more factors such that the effect when combined is greater than the predicted effect based on the response to each other when applied individually.

As used herein, the term “post-emergence,” refers to the application of the herbicide composition to the weeds that have emerged from the soil. The term “pre-emergence” refers to the application of the herbicide composition to a habitat, a weed, or soil, prior to the emergence of the weeds from the soil.

As used herein, the term “controlling of weeds and grasses in crops of the cultivated plants” refers to the interference with the normal growth and development of undesired vegetation. Examples of control activity include, but are not limited to, inhibition of root growth, inhibition of shoot growth, inhibition of shoot emergence, inhibition of seed production, or reduction of weed biomass.

Accordingly, unless indicated to the contrary, the numerical parameters set forth in the following specification and attached claims are approximations that may vary depending upon the desired properties sought to be obtained.

At the very least, each numerical parameter should at least be construed in light of the number of reported significant digits and by applying ordinary rounding techniques. In addition, the endpoints of all ranges directed to the same component or property herein are inclusive of the endpoints, are independently combinable, and include all intermediate points and ranges.

The present subject matter relates to a synergistic herbicidal mixture comprises an herbicide A which is bifenox, and an herbicide B which is selected from very long chain fatty acid inhibitor or salt thereof.

In an embodiment, the present invention relates to a synergistic herbicidal composition comprises an herbicide A which is bifenox, an herbicide B which is selected from very long chain fatty acid inhibitor or salt thereof and at least one agriculturally acceptable carrier.

In an embodiment, the very long chain fatty acid inhibitor is selected from the group comprising dimethenamid, (S)-dimethenamid, pyroxasulfone, prosulfocarb, flufenacet, alachlor, acetochlor, metolachlor, (S)-metolachlor, tri-allate, fenoxasulfone, ethofumesate, dimethachlor or thiobencarb.

In another embodiment, the herbicide A (bifenox) is present in an amount of 5 to 80% w/w and herbicide B (very long chain fatty acid inhibitor) is present in an amount of 5 to 80% w/w.

In a preferred embodiment, the herbicidal composition comprises bifenox, dimethenamid or (S)-dimethenamid and at least one agriculturally acceptable carrier, wherein bifenox is present in an amount of 5 to 80% w/w and dimethenamid or (S)-dimethenamid is present in an amount of 5 to 80% w/w.

In another embodiment, the herbicidal composition comprises bifenox, pyroxasulfone and at least one agriculturally acceptable carrier, wherein bifenox is present in an amount of 20 to 60% w/w and pyroxasulfone is present in an amount of 10 to 40% w/w.

In a further embodiment, the herbicidal composition comprises bifenox, prosulfocarb and at least one agriculturally acceptable carrier, wherein bifenox is present in an amount of 5 to 25% w/w and prosulfocarb is present in an amount of 50 to 80% w/w.

In yet another embodiment, the herbicidal composition comprises bifenox, flufenacet and at least one agriculturally acceptable carrier, wherein the bifenox is present in an amount of 5 to 80% w/w and flufenacet is present in an amount of 5 to 80% w/w.

In an embodiment, the herbicidal composition comprises bifenox, alachlor and at least one agriculturally acceptable carrier, wherein the bifenox is present in an amount of 5 to 80% w/w and alachlor is present in an amount of 5 to 80% w/w.

In another embodiment, the herbicidal composition comprises bifenox, acetochlor and at least one agriculturally acceptable carrier, wherein the bifenox is present in an amount of 5 to 80% w/w and acetochlor is present in an amount of 5 to 80% w/w.

In a further embodiment, the herbicidal composition comprises bifenox, metolachlor or (S)-metolachlor and at least one agriculturally acceptable carrier, wherein the bifenox is present in an amount of 5 to 50% w/w and metolachlor or (S)-metolachlor is present in an amount of 50 to 80% w/w.

In an embodiment, the herbicidal composition comprises bifenox, tri-allate and at least one agriculturally acceptable carrier, wherein the bifenox is present in an amount of 5 to 50% w/w and tri-allate is present in an amount of 50 to 80% w/w.

In another embodiment, the herbicidal composition comprises bifenox, fenoxasulfone and at least one agriculturally acceptable carrier, wherein the bifenox is present in an amount of 25 to 60% w/w and fenoxasulfone is present in an amount of 30 to 65% w/w.

In yet another embodiment, the herbicidal composition comprises bifenox, ethofumesate and at least one agriculturally acceptable carrier, wherein the bifenox is present in an amount of 5 to 80% w/w and ethofumesate is present in an amount of 5 to 80% w/w.

In a further embodiment, the herbicidal composition comprises bifenox, dimethachlor and at least one agriculturally acceptable carrier, wherein the bifenox is present in an amount of 5 to 80% w/w and dimethachlor is present in an amount of 5 to 80% w/w.

In an embodiment, the herbicidal composition comprises bifenox, thiobencarb and at least one agriculturally acceptable carrier, wherein the bifenox is present in an amount of 5 to 80% w/w and thiobencarb is present in an amount of 5 to 80% w/w.

The weight ratio of the herbicide A which is bifenox to the herbicide B which is very long chain fatty acid inhibitor or salt thereof cannot be generally defined, as it varies depending upon the various conditions such as the type of formulation, weather conditions, the type of crop and the type of weeds.

In an embodiment, the weight ratio of the herbicide A which is bifenox to the herbicide B which is very long chain fatty acid inhibitor is from 1:100 to 100:1. In another embodiment, the weight ratio of the herbicide A to herbicide B is from 1:50 to 50:1. In a specific embodiment, the weight ratio of the herbicide A to herbicide B is from 1:10 to 10:1. In a more specific embodiment, the weight ratio of the herbicide A to herbicide B is from 1:5 to 5:1.

The herbicidal composition of the present invention may be employed or formulated in any conventional form as Capsule suspension (CS), Dispersible concentrate (DC), Dustable powder (DP), Powder for dry seed treatment (DS), Emulsifiable concentrate (EC), Emulsifiable granule (EG), Emulsion water-in-oil (EO), Emulsifiable powder (EP), Emulsion for seed treatment (ES), Emulsion oil-inwater (EW), Flowable concentrate for seed treatment (FS), Granules (GR), Micro-emulsion (ME), Oil-dispersion (OD), Oil miscible flowable concentrate (OF), Oil miscible liquid (OL), Oil dispersible powder (OP), Suspension concentrate (SC), Suspension concentrate for direct application (SD), Suspo-emulsion (SE), Water soluble granule (SG), Soluble concentrate (SL), Spreading oil (SO), Water soluble powder (SP), Water soluble tablet (ST), Ultra-low volume (ULV) suspension, Tablet (TB), Ultra-low volume (ULV) liquid, Water dispersible granules (WG), Wettable powder (WP), Water dispersible powder for slurry seed treatment (WS), Water dispersible tablet (WT), a mixed formulation of CS and SC (ZC) or A mixed formulation of CS and SE (ZE), a mixed formulation of CS and EW (ZW), preferably the herbicidal composition is formulated as water dispersible granule, suspension concentrate, oil dispersion or emulsifiable concentrate.

In an embodiment, the amount of the active ingredients in the composition is about 0.1-99% w/w, or about 0.1-95% w/w, or about 0.1-90% w/w, based on the total weight of the composition. In another embodiment, the amount of the active ingredients in the composition is about 30-50% w/w, based on the total weight of the composition. In yet another embodiment, the amount of the active ingredients in the composition is from about 0.1%, 0.5%, 1%, 1.5%, 2%, 2.5%, 3%, 3.5%, 4%, 4.5%, 5% to about 90%, 93%, 95%, 98%, 99% based on the total weight of the composition.

The agriculturally acceptable carrier used to formulate the herbicidal composition is selected from the group comprising solvent, filler, binder, surfactant, anti-freezing agent, antifoaming, biocide, thickener, or pH modifier.

In an embodiment, the agriculturally acceptable carrier for the preparation of water dispersible granule composition is selected from the group comprising surfactant, binder, antifoaming and filler.

In another embodiment, the agriculturally acceptable carrier for the preparation of oil dispersion composition is selected from the group comprising solvent, surfactant, thickener, pH modifier, and antifoaming agent.

In a further embodiment, the agriculturally acceptable carrier for the preparation of suspension concentrate and emulsifiable concentrate composition is selected from the group comprising solvent, surfactant, anti-freezing agent, antifoaming, biocide, thickener or pH modifier.

The solvent is generally added to the composition to increase the solubility of the components of the composition. Suitable solvent used herein, but are not limited to water; aromatic hydrocarbons such as alkylbenzenes and alkylnaphthalenes; alcohols such as methanol, cyclohexanol, and decanol; ethylene glycol; polypropylene glycol; dipropropylene glycol; N,N-dimethylformamide; dimethylsulfoxide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

In the present invention, the solvent is present in an amount of 5 to 90% w/w and preferably in an amount of 5 to 80% w/w.

Surfactant (an emulsifying agent/a wetting agent/a dispersing agent) comprises anionic, non-ionic, amphoteric and polymeric surfactant or a combination thereof. It is preferred to use one or more than one kind of surfactant. Surfactants are compounds that lower the surface tension (or interfacial tension) between two liquids, between a gas and a liquid, or between a liquid and a solid.

Surfactants were added to stabilize the oil dispersion or emulsifiable concentrate composition and improving the viscosity of the liquid phase in order to prevent the insoluble actives falling out of suspension and preventing sedimentation in oil dispersion formulation and preventing breakdown in emulsifiable concentrate composition which occurs due to aggregation and coalescence.

Surfactant is selected from the group comprising, but not limited to,
polyalkoxylated, preferably polyethoxylated, saturated and unsaturated aliphatic alcohols, having 8 to 24 carbon atoms in the alkyl radical, which is derived from the corresponding fatty acids or from petrochemical products, and having 1 to 100, preferably 2 to 50, ethylene oxide units (EO), it being possible for the free hydroxyl group to be alkoxylated, which are commercially available, for example as Genapol® X such as Genapol X 150 and Genapol® O series (Clariant), Crovol® M series (Croda) or as Lutensol® series (BASF), for example Lutensol®-A series, -AT series, -AO series, -ON series, TO series or -XL series, -Imbentin series such as Imbentin T/65, Imbentin T/150;
polyalkoxylated, preferably polyethoxylated, arylalkylphenols, such as, for example, 2,4,6-tris-(1-phenylethyl)phenol (tristyrylphenol) having an average degree of ethoxylation of between 10 and 80, preferably from 16 to 40, such as, for example Soprophor® BSU (Rhodia) or HOE S 3474 (Clariant); tristyrylphenol ethoxylate phosphate ester such as Soprophor® 3D33; polyalkoxylated, preferably polyethoxylated, alkylphenols having one or more alkyl radicals, such as, for example, nonylphenol or tri-sec-butylphenol, and a degree of ethoxylation of between 2 and 40, preferably from 4 to 15, such as, for example, Arkopal® N series or Sapogenat® T series (Clariant);
polyalkoxylated, preferably polyethoxylated, hydroxyfatty acids or glycerides which contain hydroxyfatty acids, such as, for example, ricinine or castor oil, having a degree of ethoxylation of between 10 and 80, preferably from 25 to 40, such as, for example, the Emulsogen® EL series (Clariant) or the Agnique® CSO series (Cognis), Emulsogen EL-400; polyalkoxylated, preferably polyethoxylated, sorbitan esters, such as, for example, Atplus® 309 F (Unigema); Alkamuls® series (Rhodia), Tween 20; Tween 80;
alkoxylated polyol ester such as, for example Atplus UEP 100;
polyalkoxylated, preferably polyethoxylated amine, such as, for example, Genamin® series (Clariant), for example Genamin®-C series, -O series such as Genamin O 200, -S series or -T series, Imbentin® CAM series (Kolb) or Lutensol® F series (BASF);
di- and tri-block copolymers, for example from alkylene oxides, for example from ethylene oxide and propylene oxide, having average molar masses between 200 and 10000, preferably from 1000 to 4000 g/mol, the proportion by mass of the polyethoxylated block varying between 10 and 80%, such as, for example, the Genapol® PF series (Clariant), the Pluronic® series (BASF), or the Synperonic® PE series (Unigema); Atlas™ G-5002L;
alkyl polyglucoside such as decyl glucoside; polyoxyethylene alkyl ethers such as polyoxyethylene lauryl ether, or polyoxyethylene coconut fatty alcohol ether; polyoxyethylene alkynyl ether such as polyoxyethylene 2,4,7,9-tetramethyl-5-decyn-4,7-diol ether; polyoxyethylene aryl ethers such as polyoxyethylene nonylphenyl ether or polyoxyethylene tristyrylphenyl ether; polyoxyethylene fatty acid esters such as polyoxyethylene monolaurate, polyoxyethylene distearate or polyoxyethylene resin acid ester;
polyalkoxylated, preferably polyethoxylated, surfactant which are ionically modified, for example by conversion of the terminal free hydroxyl function of the polyethylene oxide block into a sulfate or phosphate ester (for example as alkali metal and alkaline earth metal salts), such as, for example, Genapol® LRO or dispersant 3618 (Clariant), Emulphor® (BASF) or Crafol® AP (Cognis);
alcohol polyglycol ether such as Ethylan NS 500 LQ®;
polyacrylate such as Dispersogen PSL 100®;
alkali metal and alkaline earth metal salts of alkylarylsulfonic acids having a straight-chain or branched alkyl chain, such as phenylsulfonate CA or phenylsulfonate CAL (Clariant), Atlox® 3377BM (ICI), or the Empiphos® TM series (Huntsman);
polyelectrolytes, such as lignosulfonates, condensates of naphthalenesulfonate and formaldehyde, polystyrenesulfonate or sulfonated unsaturated or aromatic polymers (polystyrenes, polybutadienes or polyterpenes), such as the Tamol® series (BASF), Morwet® D425 (Witco), Kraftsperse® series (Westvaco) or Borresperse® series (Borregard).
polyoxyethylene polyoxypropylene alkyl ether such as polyoxyethylene polyoxypropylene lauryl ether; polyoxyethylene polyoxypropylene aryl ether such as polyoxyethylene polyoxypropylene styrylphenyl ether; polyoxyethylene alkyl amines such as polyoxyethylene stearyl amine; polyoxyethylene fatty acid amide such as lauric acid diethanolamid; fluorinated surfactant; alkyl sulfates such as sodium lauryl sulfate; alkylbenzene sulfonate such as dodecylbenzene sulfonate calcium salt for example Nansa EVM 70/2E; phosphate ester of natural fatty alcohol such as oleyl alcohol (Croadfos O3A);
polyoxyethylene alkyl ether sulfates such as sodium polyoxyethylene lauryl ether sulfate; polyoxyethylene aryl ether sulfates such as sodium polyoxyethylene nonylphenyl ether sulfate or ammonium polyoxyethylene tristyrylphenyl ether sulfate; aryl sulfonate such as calcium dodecyl benzene sulfonate, sodium naphthalene sulfonate or sodium naphthalene sulfonate formaldehyde condensate; ‘alpha’-olefin sulfonate; alkyl sulfosuccinate such as sodium dioctyl sulfosuccinate such as Aerosol® OT-A ND; sodium lignosulfonate; polycarboxylic acid sodium salt; N-methyl fatty acid sarcosinate; polyoxyethylene alkyl ether phosphate; polyoxyethylene aryl ether phosphates such as polyoxyethylene phenyl ether phosphate; polyoxyethylene alkyl phenyl ether phosphate; graft co-polymers such as polymethyl methacrylate-polyethylene glycol graft copolymer; or a combination thereof.

In the present invention, the surfactant is present in an amount of 0.01 to 30% w/w and preferably in an amount of 0.1 to 20% w/w.

Anti-freezing agent is generally added to the composition, to prevent the aqueous compositions from freezing. Suitable anti-freezing agents used herein, but not limited to, glycerine, propylene glycol, diethylene glycol, monoethylene glycol or a combination thereof. The anti-freezing agent is present in an amount in the range from 1 to 10% w/w and preferably in an amount of 1 to 6% w/w.

Anti-foaming agent is generally added to the composition for prevention of the foam formation. Suitable anti-foaming agent used herein, but not limited to, silicone emulsion such as dimethyl polysiloxane emulsion. The anti-foaming is present in an amount in the range from 0.01 to 1% w/w and preferably in an amount of 0.01 to 0.50% w/w.

Biocide is generally added to the composition for prevention against spoilage from bacteria, yeasts and fungi. Suitable biocide used herein, but not limited to, 20% aqueous dipropylene glycol solution of 1,2-benzisothiazolin-3-one, formaldehyde, isothiazolinone or a combination thereof. The biocide is present in an amount in the range from 0.01 to 1% w/w and preferably in an amount of 0.01 to 0.50% w/w.

pH modifier is a compound that used to mix with different additives or other agrochemicals of different acidities or alkalinities. pH modifier is selected from the group comprising, but not limited to, sodium or potassium carbonate, sodium or potassium hydrogen carbonate, sodium or potassium dihydrogenphosphate, disodium or dipotassium hydrogenphosphate, citric acid, malic acid, triethanolamine, fatty acids such as lauric acid and oleic acid, fatty amines, preferably potassium carbonate. These pH modifiers may be used alone or in combination thereof. pH modifier is present in an amount of 0.01 to 2.00% w/w and preferably from 0.1 to 0.35% w/w.

The filler is selected from the group comprising china clay, bentonite, precipitated silica, fused silica, fumed silica, lactose monohydrate or a combination thereof and present in an amount of 20 to 80% w/w.

The binder is selected from a group comprising starch, methylcellulose, carboxymethyl cellulose, polyvinylpyrrolidone, starch, polyethylene glycol or combination thereof. The binder is present in an amount of 0.50 to 2% w/w.

In an embodiment, the herbicidal mixture of the present invention comprises:
a) an herbicide A which is bifenox;
b) an herbicide B which is very long chain fatty acid inhibitor;
c) optionally a safener;

In another embodiment, the herbicidal composition of the present invention comprises:
d) an herbicide A which is bifenox;
e) an herbicide B which is very long chain fatty acid inhibitor;
f) optionally a safener;
g) at least one agriculturally acceptable carrier.

In another embodiment, the safener is selected from the group comprising benoxacor, cloquintocet, cyometrinil, cyprosulfamide, dichlormid, dicyclonon, dietholate, fenchlorazole, fenclorim, flurazole, fluxofenim, furilazole, isoxadifen, jiecaowan, jiecaoxi, metcamifen, mefenpyr, mephenate, naphthalic anhydride, R-29148, AD-67, MG-191, oxabetrinil or esters thereof.

In an embodiment, the present invention relates to the use of herbicidal mixture for the selective control of weeds and grasses in crops of the cultivated plants comprising an herbicide A which is bifenox; and an herbicide B which is very long chain fatty acid inhibitor.

The present subject matter further relates to an herbicidal composition for the selective control of weeds and grasses in crops of the cultivated plants comprising an herbicide A which is bifenox; an herbicide B which is very long chain fatty acid inhibitor and an agriculturally acceptable carrier.

The herbicidal composition of the present invention may include additional crop protection agents, for example insecticides, herbicides, fungicides, bactericides, nematicides, molluscicides, plant growth regulators, biological agents, fertilizers or a combination thereof.

In an embodiment, the herbicidal composition of the present invention may be applied in conjunction with one or more co-herbicides to control a wider variety of weeds and grasses in the crops of the cultivated plants.

In another embodiment, the present invention relates to a method of controlling of weeds and grasses in the crops of the cultivated plants comprising applying to the locus of the weeds and grasses an herbicidally effective amount of a composition of an herbicide A which is bifenox, an herbicide B which is selected from very long chain fatty acid inhibitor and an agriculturally acceptable carrier.

In a preferred embodiment, the herbicidal mixture or composition of the present invention can be applied pre-emergence or post-emergence depending on the emergence of weeds and grasses in the crops of the cultivated plants.

In another embodiment, the herbicidal mixture or its composition of the present invention is applied on the crops of cultivated plants which include one or more of cereals, wheat, barley, oats, winter wheat, spring wheat, winter barley, spring barley, triticale, cereal rye, winter durum wheat, spring durum wheat, winter oat, spring oat, fodder cereals, fodder beet, maize, sugar beet, soybean, canola, oilseed rape, cotton, sunflower, sorghum, rice, forestry, turfgrass, sugar cane, ray-grass, cocksfoot, fescue, timothy, grass for seed and grassland and non-crop areas.

In yet another embodiment, the undesired vegetation may include one or more of Alopecurus spp. such as Alopecurus myosuroides, Alopecurus aequalis; Apera spp. such as Apera spica-venti; Avena fatua, Avena sterilis, Brachiaria spp. such as Brachiaria plantaginea, Brachiaria decumbens; Bromus spp. such as Bromus secalinus, Bromus sterilis, Bromus tectorum; Cyonodon spp.; Digitaria spp. such as Digitaria ciliaris, Digitaria insularis, Digitaria ischaemum, Digitaria sanguinalis; Echinochloa spp. such as Echinochloa corona, Echinochloa crus-galli, Echinochloa crus-pavonis, Echinochloa erecta, Echinochloa oryzoides, Echinochloa phyllogogon; Eleusine indica, Ischaemum rugosum, Leptochloa spp. such as Leptochloa chinensis, Leptochloa panicoides, Leptochloa scabra, Leptochloa virgata; Lolium spp. such as Lolium multiflorum, Lolium perenne, Lolium rigidum; Panicum spp. such as Panicum capillare, Panicum dichotomiflorum; Phalaris brachystachyx, Phalaris minor, Phalaris paradoxa, Poa spp. such as Poa annua, Poa pratensis, Poa trivialis; Pennisetum spp., Rottboelia exaltata, Setaria spp. such as Setariafaberi, Setaria glauca, Setaria pumila, Setaria verticillata, Setaria viridis; Urochloa spp., Vulpia spp., Ageratum spp., Amaranthus spp. such as Amaranthus albus, Amaranthus blitoides, Amaranthus hybridus, Amaranthus palmeri, Amaranthus powellii, Amaranthus retroflexus, Amaranthus tuberculatus, Amaranthus rudis, Amaranthus viridis; Ambrosia artemisifolia, Anthemis arvensis, Arctotheca calendula, Bifora testiculata, Boerhavia dominii, Brassica napus, Brassica nigra, Capsella bursa-pastoris, Centaurea cyanus, Chenopodium spp. such as Chenopodium album, Chenopodium ficifolium, Chenopodium polyspermum, Chenopodium hybridum; Conyza spp. such as Conyza bonariensis, Conyza canadensis; Cotula australis, Crassula spp., Descurania sophia, Datura stromonium, Echium plantagineum, Emex australis, Erodium spp., Fallopia convolvulus, Fumaria spp., Galium spp. such as Galium aparine, Galium spurium, Galium tricornutum; Kochia scoparia, Matricaria chamomilla, Matricaria discoidea, Matricaria inodora, Heliotropium spp., Ipomoea spp., Juncus bufonius, Lactuca serriola, Lamium spp., Malva spp., Medicago spp., Papaver spp. such as Papaver rhoeas; Polygonum spp., Portulaca oleracea, Persicaria lapathifolia, Raphanus raphanistrum, Rapistrum spp., Sida spp., Sinapis alba, Sinapis arvensis, Sisymbrium spp. such as Sisymbrium officinale, Sisymbrium orientale; Solanum nigrum, Sonchus oleraceus, Stellaria media, Tetragonia tetragoniodides, Trianthema portulacastrum, Tripleurospermum inodorum, Tribulus spp., Trifolium subterraneum, Thlaspi arvense, Urtica urens, Vicia sativa (Vetches), Veronica spp.

The herbicidally effective amounts of the herbicidal mixture or its composition thereof comprises an herbicide A which is bifenox and an herbicide B which is selected from very long chain fatty acid inhibitor cannot be generally defined, as it varies depending upon various conditions such as the type of the formulation, weather conditions, the type of crop and the type of weeds.

In an embodiment, the herbicidal mixture or composition is applied to the locus of weeds and grasses in in crops of the cultivated plants in an amount of from 1 to 5000 g/ha. In another embodiment, the herbicidal composition is applied in an amount of from 100 to 5000 g/ha. In a further embodiment, the herbicidal composition is applied in an amount of from 200-500 g/ha.

In an embodiment, the herbicidal mixture or composition is applied to the locus of weeds and grasses in in crops of the cultivated plants in an amount, or at a rate of application, of from 0.01 to 100 liter/ha. In another embodiment, the herbicidal composition is applied in an amount of from 0.1 to 10 liter/ha. In yet another embodiment, the herbicidal composition is applied in an amount of from 0.1 to 1 liter/ha.

The present invention is further illustrated by the following examples. These examples describe possible preferred embodiments for illustrative purposes only, but they do not limit the scope of the invention.

Following the test results illustrate the present invention and are not intended to limit the present invention.

### Example 1

A field trial experiments were conducted in Hungary to evaluate the efficacy of the combination of bifenox and (S)-dimethenamid composition. The combination is also evaluated in comparison to solo applications of bifenox and (S)-dimethenamid composition. The target crop was sunflower and targeted weeds were evaluated include Chenopodium album (CHEAL), Datura Stramonium (DATST), Tripleurospermum inodorum (MATIN), and Setaria viridis (SETVI).

Treatments were applied using a motorized laboratory sprayer equipped with an BACCAI spay equipment, flat fan nozzle delivering 200 to 300 L ha⁻¹ at 200 to 280 kPa. The treatment details are shown below in Table 1. The synergistic effect of the combination of bifenox and (S)-dimethenamid is being evaluated in terms of weed control. Percent mortality of weeds at 57DAA to 72DAA after application was recorded and average of it presented in Table 2 and Table 3.

TABLE 1
Treatment details to access the weed control effect of the
combination of bifenox and (S)-dimethenamid composition.

| | Product | | | |
|---|---|---|---|---|
| S. | (Test | Active ingredient | | |
| No. | compounds) | and concentration | Dose rate (L/ha) | |
| 1 | FOX | Bifenox 480 SC | 1.5 | L/ha |
| 2 | SPECTRUM | (S)-Dimethenamid 720 EC | 1 | L/ha |
| 3 | SPECTRUM | (S)-Dimethenamid 720 EC | 0.7 | L/ha |
| 4 | FOX + | Bifenox 480 SC + (S)- | 1.5 + 1 | L/ha |
| | SPECTRUM | Dimethenamid 720 EC | | |
| 5 | FOX + | Bifenox 480 SC + (S)- | 1.5 + 0.7 | L/ha |
| | SPECTRUM | Dimethenamid 720 EC | | |

TABLE 2
Percentage control of Chenopodium album (CHEAL) and Datura Stramonium (DATST):

| | | | CHEAL | | | DATST | | |
|---|---|---|---|---|---|---|---|---|
| | Product | Dose | % | % | Colby's | % | % | Colby's |
| S. | (Test | rate | Observed | Expected | Ratio | Observed | Expected | Ratio |
| No. | compounds) | (L/ha) | (O) | (E) | (O/E) | (O) | (E) | (O/E) |
| 1 | FOX | 1.5 | 56 | — | — | 0 | — | — |
| | | L/ha | | | | | | |
| 2 | SPECTRUM | 1 L/ha | 56 | — | — | 49 | — | — |
| 3 | SPECTRUM | 0.7 | 46 | — | — | 3 | — | — |
| | | L/ha | | | | | | |
| 4 | FOX + | 1.5 + 1 | 99 | 80.64 | 1.23 | 100 | 49 | 2.04 |
| | SPECTRUM | L/ha | | | | | | |
| 5 | FOX + | 1.5 + | 97 | 76.24 | 1.27 | 93 | 3 | 31.00 |
| | SPECTRUM | 0.7 | | | | | | |
| | | L/ha | | | | | | |

TABLE 3
Percentage control of Tripleurospermum inodorum (MATIN) and Setaria viridis (SETVI):

| | | | MATIN | | | SETVI | | |
|---|---|---|---|---|---|---|---|---|
| | Product | Dose | % | % | Colby's | % | % | Colby's |
| S. | (Test | rate | Observed | Expected | Ratio | Observed | Expected | Ratio |
| No. | compounds) | (L/ha) | (O) | (E) | (O/E) | (O) | (E) | (O/E) |
| 1 | FOX | 1.5 | 85 | — | — | 10 | — | — |
| | | L/ha | | | | | | |
| 2 | SPECTRUM | 1 L/ha | 78 | — | — | 95 | — | — |
| 3 | SPECTRUM | 0.7 | 82 | — | — | 67 | — | — |
| | | L/ha | | | | | | |
| 4 | FOX + | 1.5 + 1 | 99 | 96.70 | 1.02 | 96 | 95.50 | 1.01 |
| | SPECTRUM | L/ha | | | | | | |
| 5 | FOX + | 1.5 + | 98 | 97.30 | 1.01 | 89 | 70.30 | 1.27 |
| | SPECTRUM | 0.7 | | | | | | |
| | | L/ha | | | | | | |

### Result:

Combination of bifenox and (S)-dimethenamid composition at an application rate of 1.5 L/ha (bifenox)+1 or 0.7 L/ha (S)-dimethenamid was highly effective in controlling the weeds and grasses in comparison to the solo application of bifenox and (S)-dimethenamid composition.

### Example 2

A field trial was established in Australia to evaluate the efficacy of the combination of bifenox and prosulfocarb or pyroxasulfone compositions. Bifenox, prosulfocarb and pyroxasulfone compositions were applied as solo applications and in combinations of bifenox and prosulfocarb; and bifenox and pyroxasulfone. The target crop was wheat, and the target weed was wild radish (Raphanus raphanistrum).

Treatments were applied using a hand boom sprayer equipped with Airmix 110-015 flat fan nozzle delivering 100 L ha⁻¹ at 250 kPa. The treatment details are shown below in Table 4. The synergistic effect of the combination of bifenox and prosulfocarb or pyroxasulfone is being evaluated in terms of weed control. Percentage control of wild radish (Raphanus raphanistrum) 31 and 56 days after application was recorded and presented in Table 5.

TABLE 4
Treatment details to access the weed control effect of the combination
of bifenox and prosulfocarb or pyroxasulfone compositions.

| S. | Product | Active ingredient | Dose rate | |
|---|---|---|---|---|
| No. | (Test compounds) | and concentration | per hectare | |
| 1 | FOX | Bifenox 480 SC | 2 | L |
| 2 | COUNTDOWN | Prosulfocarb 800 EC | 2.5 | L |
| 3 | NOVALI | Pyroxasulfone 850 WG | 118 | g |

| | | | |
|---|---|---|---|
| 4 | FOX + COUNTDOWN | Bifenox 480 SC + | 2 L + 2.5 L |
| | | Prosulfocarb 800 EC | |
| 5 | FOX + NOVALI | Bifenox 480 SC + | 2 L + 118 g |
| | | Pyroxasulfone 850 WG | |

TABLE 5
Percentage control of wild radish (Raphanus raphanistrum):

| | | | % OBSERVED | | % EXPECTED | | Colby's Ratio | |
|---|---|---|---|---|---|---|---|---|
| | Product | Product | (O) | | (E) | | (O/E) | |
| S. | (Test | rate per | 31 | 56 | 31 | 56 | 31 | 56 |
| No. | compounds) | hectare | DAA | DAA | DAA | DAA | DAA | DAA |
| 1 | FOX | 2 L | 55 | 65 | — | — | — | — |
| 2 | COUNTDOWN | 2.5 L | 26 | 10 | — | — | — | — |
| 3 | NOVALI | 118 g | 51 | 58 | — | — | — | — |
| 4 | FOX + | 2 L + | 80 | 76 | 67 | 69 | 1.19 | 1.10 |
| | COUNTDOWN | 2.5 L | | | | | | |
| 5 | FOX + | 2 L + | 86 | 86 | 78 | 85 | 1.10 | 1.01 |
| | NOVALI | 118 g | | | | | | |

DAA—days after application

### Result:

Combination of bifenox and prosulfocarb composition at an application rate of 2 L/ha (bifenox)+2.5 L/ha (prosulfocarb) was synergistic for controlling wild radish in comparison to the solo application of bifenox and prosulfocarb composition.
Combination of bifenox and pyroxasulfone composition at an application rate of 2 L/ha (bifenox)+118 g/ha (pyroxasulfone) was synergistic for controlling wild radish in comparison to the solo application of bifenox and pyroxasulfone composition.

### Example 3

A field trial was established in Australia to evaluate the efficacy of the combination of bifenox and triallate compositions. Bifenox and triallate compositions were applied as solo applications and in combination. The target crop was wheat, and the target weeds were wild radish (Raphanus raphanistrum), barnyard grass (Echinochloa crus-galli) and ryegrass (Lolium rigidum).

Treatments were applied using a hand boom sprayer equipped with Airmix 110-015 flat fan nozzle delivering 100 L ha⁻¹ at 250 kPa. The treatment details are shown below in Table 6. Percentage control of wild radish (Raphanus raphanistrum), barnyard grass (Echinochloa crus-galli) and ryegrass (Lolium rigidum) 28 days after application (DAA) was recorded and presented in Table 7 and Table 8.

TABLE 6
Treatment details to access the weed control effect of
the combination of bifenox and triallate compositions:

| S. | Product | Active ingredient | Dose rate |
|---|---|---|---|
| No. | (Test compounds) | and concentration | (g a.i./ha) |
| 1 | FOX | Bifenox 480 SC | 240 |
| 2 | Avadex Xtra | Triallate 500 EC | 150 or 300 |
| 3 | FOX + Avadex Xtra | Bifenox 480 SC + | 240 + 150 |
| | | Triallate 500 EC | |
| 4 | FOX + Avadex Xtra | Bifenox 480 SC + | 240 + 300 |
| | | Triallate 500 EC | |

TABLE 7
Percentage control of barnyard grass and ryegrass (28 DAA):

| | | Dose | BARNYARD GRASS (28 DAA) | | | RYEGRASS (28 DAA) | | |
|---|---|---|---|---|---|---|---|---|
| | Product | rate | % | % | Colby's | % | % | Colby's |
| S. | (Test | (g | Observed | Expected | Ratio | Observed | Expected | Ratio |
| No. | compounds) | a.i./ha) | (O) | (E) | (O/E) | (O) | (E) | (O/E) |
| 1 | FOX | 240 | 35.0 | — | — | 0.0 | — | — |
| 2 | Avadex Xtra | 150 | 3.3 | — | — | 51.7 | — | — |
| 3 | Avadex Xtra | 300 | 21.7 | — | — | 78.3 | — | — |
| 4 | FOX + | 240 + | 43.3 | 37.2 | 1.17 | 48.3 | 51.7 | 0.94 |
| | Avadex Xtra | 150 | | | | | | |
| 5 | FOX + | 240 + | 51.7 | 49.1 | 1.05 | 81.7 | 78.3 | 1.04 |
| | Avadex Xtra | 300 | | | | | | |

TABLE 8
Percentage control of wild radish (28 DAA):

| | | | WILD RADISH (28 DAA) | | |
|---|---|---|---|---|---|
| | Product | | | | Colby's |
| S. | (Test | Dose rate | % Observed | % Expected | Ratio |
| No. | compounds) | (g a.i./ha) | (O) | (E) | (O/E) |
| 1 | FOX | 240 | 16.7 | — | — |
| 2 | Avadex Xtra | 150 | 5.0 | — | — |
| 3 | Avadex Xtra | 300 | 0.0 | — | — |
| 4 | FOX + Avadex | 240 + 150 | 6.7 | 20.8 | 0.32 |
| | Xtra | | | | |
| 5 | FOX + Avadex | 240 + 300 | 40.0 | 16.7 | 2.40 |
| | Xtra | | | | |

### Result:

Combination of bifenox and triallate compositions was synergistic for controlling barnyard grass, ryegrass and wild radish in comparison to the solo application of bifenox and triallate composition.

### Example 4

A field trial was established in Australia to evaluate the efficacy of the combination of bifenox and ethofumesate compositions. Bifenox and ethofumesate compositions were applied as solo applications and in combination. The target crop was wheat, and the target weed was barnyard grass (Echinochloa crus-galli).

Treatments were applied using a hand boom sprayer equipped with Airmix 110-015 flat fan nozzle delivering 100 L ha⁻¹ at 250 kPa. The treatment details are shown below in Table 9. Percentage control of barnyard grass 28 days after application (DAA) was recorded and presented in Table 10.

TABLE 9
Treatment details to access the weed control effect of the
combination of bifenox and ethofumesate compositions:

| S. | Product | Active ingredient | Dose rate |
|---|---|---|---|
| No. | (Test compounds) | and concentration | (g a.i./ha) |
| 1 | FOX | Bifenox 480 SC | 240 |
| 2 | Matrix | Ethofumesate 500 SC | 75 or 150 |
| 3 | FOX + Matrix | Bifenox 480 SC + | 240 + 75 |
| | | Ethofumesate 500 SC | |
| 4 | FOX + Matrix | Bifenox 480 SC + | 240 + 150 |
| | | Ethofumesate 500 SC | |

TABLE 10
Percentage control of barnyard grass (28 DAA):

| | | | BARNYARD GRASS (28 DAA) | | |
|---|---|---|---|---|---|
| | Product | | | | Colby's |
| S. | (Test | Dose rate | % Observed | % Expected | Ratio |
| No. | compounds) | (g a.i./ha) | (O) | (E) | (O/E) |
| 1 | FOX | 240 | 35.0 | — | — |
| 2 | Matrix | 75 | 13.5 | — | — |
| 3 | Matrix | 150 | 15.1 | — | — |
| 4 | FOX + Matrix | 240 + 75 | 41.7 | 55.6 | 0.75 |
| 5 | FOX + Matrix | 240 + 150 | 58.3 | 45.8 | 1.27 |

### Result:

Combination of bifenox and ethofumesate compositions was synergistic for controlling barnyard grass, in comparison to the solo application of bifenox and ethofumesate composition.

### Example 5

A field trial was established in Australia to evaluate the efficacy of the combination of bifenox and thiobencarb compositions. Bifenox and thiobencarb compositions were applied as solo applications and in combination. The target crop was wheat, and the target weed was barnyard grass (Echinochloa crus-galli), annual ryegrass (Lolium ridigum) and wild radish (Raphanus raphistrum).

Treatments were applied using a hand boom sprayer equipped with Airmix 110-015 flat fan nozzle delivering 100 L ha⁻¹ at 250 kPa. The treatment details are shown below in Table 10 and Table 13. Percentage control of barnyard grass and annual ryegrass 28 days after application (DAA) is presented in Table 12 and for wild radish in Table 13.

TABLE 11
Treatment details to access the weed control effect of the
combination of bifenox and thiobencarb compositions:

| S. | Product | Active ingredient | Dose rate |
|---|---|---|---|
| No. | (Test compounds) | and concentration | (g a.i./ha) |
| 1 | FOX | Bifenox 480 SC | 240 or 480 |
| 2 | Saturn | Thiobencarb 800 EC | 200 or 400 |
| 3 | FOX + Saturn | Bifenox 480 SC + | 240 + 200 |
| | | Thiobencarb 800 EC | |
| 4 | FOX + Saturn | Bifenox 480 SC + | 240 + 400 |
| | | Thiobencarb 800 EC | |
| 5 | FOX + Saturn | Bifenox 480 SC + | 480 + 200 |
| | | Thiobencarb 800 EC | |
| 6 | FOX + Saturn | Bifenox 480 SC + | 480 + 400 |
| | | Thiobencarb 800 EC | |

TABLE 12
Percentage control of barnyard grass and ryegrass (28 DAA):

| | | Dose | BARNYARD GRASS (28 DAA) | | | RYEGRASS (28 DAA) | | |
|---|---|---|---|---|---|---|---|---|
| | Product | rate | % | % | Colby's | % | % | Colby's |
| S. | (Test | (g | Observed | Expected | Ratio | Observed | Expected | Ratio |
| No. | compounds) | a.i./ha) | (O) | (E) | (O/E) | (O) | (E) | (O/E) |
| 1 | FOX | 240 | 35.0 | — | — | 0.0 | — | — |
| 2 | FOX | 480 | 80.0 | — | — | 10.0 | — | — |
| 3 | Saturn | 200 | 83.3 | — | — | 81.7 | — | — |
| 4 | Saturn | 400 | 94.0 | — | — | 95.0 | — | — |
| 5 | FOX + | 240 + | 90.7 | 89.2 | 1.02 | 88.3 | 81.7 | 1.08 |
| | Saturn | 200 | | | | | | |
| 6 | FOX + | 240 + | 100.0 | 96.1 | 1.04 | 94.0 | 95.0 | 0.99 |
| | Saturn | 400 | | | | | | |
| 7 | FOX + | 480 + | 92.0 | 96.7 | 0.95 | 87.3 | 83.5 | 1.05 |
| | Saturn | 200 | | | | | | |
| 8 | FOX + | 480 + | 98.3 | 98.8 | 1.00 | 93.3 | 95.5 | 0.98 |
| | Saturn | 400 | | | | | | |

TABLE 13
Percentage control of wild radish (28 DAA):

| | | | WILD RADISH (28 DAA) | | |
|---|---|---|---|---|---|
| | Product | | | | Colby's |
| S. | (Test | Dose rate | % Observed | % Expected | Ratio |
| No. | compounds) | (g a.i./ha) | (O) | (E) | (O/E) |
| 1 | FOX | 480 | 23.3 | — | — |
| 2 | Saturn | 200 | 0.0 | — | — |
| 3 | Saturn | 400 | 0.0 | — | — |
| 4 | FOX + Saturn | 480 + 200 | 31.7 | 23.3 | 1.36 |
| 5 | FOX + Saturn | 480 + 400 | 31.7 | 23.3 | 1.36 |

### Result:

Combination of bifenox and thiobencarb combination was synergistic for controlling barnyard grass, ryegrass and wild radish in comparison to the solo application of Bifenox and thiobencarb composition.

Thus, from the foregoing description, it will be apparent to one of the person skilled in the art that many changes and modifications can be made thereto without departing from the spirit or scope of the invention as set forth in the description. Accordingly, it is not intended that the scope of the foregoing description be limited to the description set forth above, but rather that such description be construed as encompassing such features that reside in the present invention, including all the features and embodiments that would be treated as equivalents thereof by those skilled in the relevant art.

We claim:

1. An herbicidal mixture comprising:
a) an herbicide A which is Bifenox;
b) at least one herbicide B which is selected from very long chain fatty acid inhibitor or salt thereof.

2. The herbicidal mixture as claimed in claim 1, wherein the herbicide B is selected from the group comprising dimethenamid, (S)-dimethenamid, pyroxasulfone, prosulfocarb, flufenacet, alachlor, acetochlor, metolachlor, (S)-metolachlor, tri-allate, fenoxasulfone, ethofumesate, dimethachlor, or thiobencarb.

3. The herbicidal mixture as claimed in claim 1, wherein the herbicide A is present in an amount of 5 to 80% w/w and herbicide B is present in an amount of 5 to 80% w/w.

4. The herbicidal mixture as claimed in claim 1, wherein the relative amount of herbicide A to herbicide B is from 1:100 to 100:1.

5. The herbicidal mixture as claimed in claim 4, wherein the relative amount of herbicide A to herbicide B is from 1:10 to 10:1.

6. An herbicidal composition comprising:
a) the herbicidal mixture as claimed in claim 1;
b) at least one agriculturally acceptable carrier.

7. The herbicidal composition as claimed in claim 6, wherein the composition is one of:
a) bifenox, dimethenamid and at least one agriculturally acceptable carrier;
b) bifenox, (S)-dimethenamid and at least one agriculturally acceptable carrier;
c) bifenox, pyroxasulfone and at least one agriculturally acceptable carrier;
d) bifenox, prosulfocarb and at least one agriculturally acceptable carrier;
e) bifenox, flufenacet and at least one agriculturally acceptable carrier;
f) bifenox, alachlor and at least one agriculturally acceptable carrier;
g) bifenox, acetochlor and at least one agriculturally acceptable carrier;
h) bifenox, metolachlor and at least one agriculturally acceptable carrier;
i) bifenox, (S)-metolachlor and at least one agriculturally acceptable carrier;
j) bifenox, tri-allate and at least one agriculturally acceptable carrier;
k) bifenox, fenoxasulfone and at least one agriculturally acceptable carrier;
l) bifenox, ethofumesate and at least one agriculturally acceptable carrier;
m) bifenox, dimethachlor and at least one agriculturally acceptable carrier;
n) bifenox, thiobencarb and at least one agriculturally acceptable carrier.

8. The herbicidal composition as claimed in claim 7, wherein the herbicidal composition is one of:
a) bifenox in an amount of 5 to 80% w/w, dimethenamid in an amount of 5 to 80% w/w and at least one agriculturally acceptable carrier;
b) bifenox in an amount of 5 to 80% w/w, (S)-dimethenamid in an amount of 5 to 80% w/w and at least one agriculturally acceptable carrier;
c) bifenox in an amount of 20 to 60% w/w, pyroxasulfone in an amount of 10 to 40% w/w and at least one agriculturally acceptable carrier;
d) bifenox in an amount of 5 to 25% w/w, prosulfocarb in an amount of 50 to 80% w/w and at least one agriculturally acceptable carrier;
e) bifenox in an amount of 5 to 80% w/w, flufenacet in an amount of 5 to 80% w/w and at least one agriculturally acceptable carrier;
f) bifenox in an amount of 5 to 80% w/w, alachlor in an amount of 5 to 80% w/w and at least one agriculturally acceptable carrier;
g) bifenox in an amount of 5 to 80% w/w, acetochlor in an amount of 5 to 80% w/w and at least one agriculturally acceptable carrier;
h) bifenox in an amount of 5 to 50% w/w, metolachlor in an amount of 50 to 80% w/w and at least one agriculturally acceptable carrier;
i) bifenox in an amount of 5 to 50% w/w, (S)-metolachlor in an amount of 50 to 80% w/w and at least one agriculturally acceptable carrier;
j) bifenox in an amount of 5 to 50% w/w, tri-allate in an amount of 50 to 80% w/w and at least one agriculturally acceptable carrier;
k) bifenox in an amount of 25 to 60% w/w, fenoxasulfone in an amount of 30 to 65% w/w and at least one agriculturally acceptable carrier;
l) bifenox in an amount of 5 to 80% w/w, ethofumesate in an amount of 5 to 80% w/w and at least one agriculturally acceptable carrier;
m) bifenox in an amount of 5 to 80% w/w, dimethachlor in an amount of 5 to 80% w/w and at least one agriculturally acceptable carrier;
n) bifenox in an amount of 5 to 80% w/w, thiobencarb in an amount of 5 to 80% w/w and at least one agriculturally acceptable carrier.

9. The herbicidal composition as claimed in claim 6, wherein the composition is formulated as Capsule suspension (CS), Dispersible concentrate (DC), Dustable powder (DP), Powder for dry seed treatment (DS), Emulsifiable concentrate (EC), Emulsifiable granule (EG), Emulsion water-in-oil (EO), Emulsifiable powder (EP), Emulsion for seed treatment (ES), Emulsion oil-inwater (EW), Flowable concentrate for seed treatment (FS), Granules (GR), Micro-emulsion (ME), Oil-dispersion (OD), Oil miscible flowable concentrate (OF), Oil miscible liquid (OL), Oil dispersible powder (OP), Suspension concentrate (SC), Suspension concentrate for direct application (SD), Suspo-emulsion (SE), Water soluble granule (SG), Soluble concentrate (SL), Spreading oil (SO), Water soluble powder (SP), Water soluble tablet (ST), Ultra-low volume (ULV) suspension, Tablet (TB), Ultra-low volume (ULV) liquid, Water dispersible granules (WG), Wettable powder (WP), Water dispersible powder for slurry seed treatment (WS), Water dispersible tablet (WT), a mixed formulation of CS and SC (ZC) or A mixed formulation of CS and SE (ZE), a mixed formulation of CS and EW (ZW).

10. The herbicidal composition as claimed in claim 6, wherein the herbicidal composition is formulated as water dispersible granule, suspension concentrate, oil dispersion or emulsifiable concentrate.

11. The herbicidal mixture as claimed in claim 1 or its composition thereof as claimed in claim 6, wherein the herbicidal mixture or its composition further comprises a safener.

12. The herbicidal mixture or its composition as claimed in claim 11, wherein the safener is selected from the group comprising benoxacor, cloquintocet, cyometrinil, cyprosulfamide, dichlormid, dicyclonon, dietholate, fenchlorazole, fenclorim, flurazole, fluxofenim, furilazole, isoxadifen, jiecaowan, jiecaoxi, metcamifen, mefenpyr, mephenate, naphthalic anhydride, R-29148, AD-67, MG-191, oxabetrinil or esters thereof.

13. The herbicidal composition as claimed in claim 6, wherein the agriculturally acceptable carrier is selected from the group comprising solvent, filler, binder, surfactant, anti-freezing agent, antifoaming, biocide, thickener, or pH modifier.

14. The herbicidal composition as claimed in claim 13, wherein the solvent is selected from the group comprising water, aromatic hydrocarbon, alcohol, ethylene glycol, polypropylene glycol, dipropropylene glycol, N,N-dimethylformamide, dimethylsulfoxide, N-alkylpyrrolidone, oil, fatty acid ester, ketone or a combination thereof and present in an amount of 5 to 80% w/w.

15. The herbicidal composition as claimed in claim 13, wherein the surfactant is selected from the group comprising non-ionic, amphoteric, polymeric surfactant or a combination thereof and it is present in an amount of 0.01 to 20% w/w.

16. The herbicidal composition as claimed in claim 13, wherein the anti-freezing agent is selected from the group comprising glycerine, propylene glycol, diethylene glycol, monoethylene glycol or a combination thereof, and present in an amount of 1 to 6% w/w.

17. The herbicidal composition as claimed in claim 13, wherein the antifoaming is selected from the group comprising silicone emulsion, dimethyl polysiloxane emulsion, polysiloxane emulsion and present in an amount of 0.01 to 0.50% w/w.

18. The herbicidal composition as claimed in claim 13, wherein the biocide is selected from the group comprising 20% aqueous dipropylene glycol solution of 1,2-benzisothiazolin-3-one, formaldehyde, isothiazolinone or a combination thereof and present in an amount of 0.01 to 0.50% w/w.

19. The herbicidal composition as claimed in claim 13, wherein the pH modifier is selected from the group comprising sodium or potassium carbonate, sodium or potassium hydrogen carbonate, sodium or potassium dihydrogenphosphate, disodium or dipotassium hydrogenphosphate, citric acid, malic acid, triethanolamine, fatty acids such as lauric acid and oleic acid, fatty amines or a combination thereof and present in an amount of 0.01 to 2.00% w/w.

20. The herbicidal composition as claimed in claim 13, wherein the filler is selected from the group comprising china clay, bentonite, precipitated silica, fused silica, fumed silica, lactose monohydrate or a combination thereof and present in an amount of 20 to 80% w/w.

21. The herbicidal composition as claimed in claim 13, wherein the binder is selected from the group comprising starch, methylcellulose, carboxymethyl cellulose, polyvinylpyrrolidone, starch, polyethylene glycol or a combination thereof and present in an amount of 0.50 to 2% w/w.

22. A method for controlling weeds and grasses in crops of the cultivated plants, wherein the effective amount of herbicidal mixture as claimed in claim 1 or its composition thereof as claimed in claim 6 is applied to the crops of cultivated plants or their habitat.

23. The method as claimed in claim 22, wherein the crops of cultivated plants are cereals, wheat, barley, oats, winter wheat, spring wheat, winter barley, spring barley, triticale, cereal rye, winter durum wheat, spring durum wheat, winter oat, spring oat, fodder cereals, maize, sugar beet, fodder beet, soybean, canola, oilseed rape, cotton, sunflower, sorghum, rice, forestry, turfgrass, sugar cane, ray-grass, cocksfoot, fescue, timothy, grass for seed and grassland, non-crop areas.

24. The method as claimed in claim 22, wherein the crops of useful plants are treated with the herbicidal composition mentioned at application rates which correspond to a total amount of active compound of from 100 to 5000 g per hectare.

25. The method as claimed in claim 22, wherein the crops of useful plants are treated with the herbicidal composition is used to provide a rate of application of from 0.1 to 10 liter/ha.

26. The method as claimed in claim 22, wherein the weeds selected from the group comprising Alopecurus spp., Apera spp., Avena spp., Brachiaria spp., Bromus spp., Chloris spp., Cynodon dactylon, Digitaria spp., Echinochloa spp., Eleusine indica, Leptochloa spp., Lolium spp., Hordeum glaucum, Panicum spp., Pennisetum spp., Phalaris minor, Phalaris paradoxa, Poa spp., Setaria spp., Urochloa spp., Vulpia spp., Ageratum spp., Amaranthus spp., Arctotheca calendula, Bifora testiculata, Boerhavia dominii, Brassica napus, Capsella bursa-pastoris, Chenopodium spp., Conyza spp., Cotula australis, Crassula spp., Datura stromonium, Echium plantagineum, Emex australis, Erodium spp., Fallopia convolvulus, Fumaria spp., Galium spp., Heliotropium spp., Ipomoea spp., Juncus bufonius, Lactuca serriola, Lamium spp., Malva spp., Medicago spp., Papaver spp., Polygonum spp., Portulaca oleracea, Persicaria lapathifolia, Raphanus raphanistrum, Rapistrum spp., Sida spp., Sinapsis arvensis, Sisymbrium spp., Solanum nigrum, Sonchus oleraceus, Stellaria media, Tetragonia tetragoniodides, Trianthema portulacastrum, Tribulus spp., Tripleurospermum inodorum, Trifolium subterraneum, Urtica urens, Vicia sativa, Veronica spp. and Xanthium spp.

27. The method as claimed in claim 26, wherein the weeds selected from the group comprising Ambrosia artemisiifolia, Echinochloa crus-galli, Persicaria lapathifolia, Chenopodium album, Datura Stramonium, Tripleurospermum inodorum, Setaria viridis, Lolium rigidum or Raphanus raphanistrum.
